(19) United States
(12) Patent Application Publication
(10) Pub. No.: US 2025/0223906 A1
(43) Pub. Date: Jul. 10, 2025

(54) ROTOR STAGE FOR A GAS TURBINE ENGINE

(71) Applicant: Rolls-Royce plc, London (GB)

(72) Inventor: Nigel J. CHIVERS, Derby (GB)

(73) Assignee: Rolls-Royce plc, London (GB)

(21) Appl. No.: 18/975,522

(22) Filed: Dec. 10, 2024

(30) Foreign Application Priority Data
Jan. 4, 2024 (GB) 2400108.3

(51) Int. Cl. F01D 5/10

(52) U.S. Cl. CPC F01D 5/10; F05D 2240/80; F05D 2260/31; F05D 2260/96; F05D 2300/603

(57) ABSTRACT

The present disclosure relates to a rotor stage 100 for a gas turbine engine 10 comprising: a platform 120 having a first material composition, a plurality of blades 160 extending from the platform 120, and a damper element 200. The platform 120 comprises a platform engagement surface 110. The damper element comprises a body portion 201 and an engagement portion 205. The engagement portion 205 has a second material composition comprising a composite friction material. The engagement portion 205 comprises a damper engagement surface 210 that engages with the platform engagement surface 110.

This disclosure claims the benefit of UK Patent Application No. GB 2400108.3, filed on 4^{th} January 2024, which is hereby incorporated herein in its entirety.

### BACKGROUND

### Technical Field

This disclosure concerns a rotor stage for a gas turbine engine. The rotor stage comprises an under-platform damper element having an engagement portion formed from a composite frictional material. This disclosure also concerns a gas turbine engine comprising such a rotor stage.

### Background of the Disclosure

A gas turbine engine comprises various stages of rotor blades which rotate in use. Typically, a gas turbine engine would have at least one compressor rotor stage, and at least one turbine rotor stage. There are a number of ways in which the blades of a rotor stage may be attached to the engine. Generally, the blades attach to a rotating component, such as a disc, that is linked to a rotating shaft. Conventionally, blades have been inserted and locked into slots formed in such discs.

Integral bladed disc rotors, also referred to as blisks (or bliscs), have also been proposed. Such blisks may be, for example, machined from a solid component, or may be manufactured by friction welding (for example linear friction welding) of the blades to the rim of the disc rotor. Blisks have a number of advantages when compared with more traditional bladed disc rotor assemblies. For example, blisks are generally lighter than equivalent bladed disc assemblies in which the blades are inserted and locked into slots in the disc because traditional blade to disc mounting features, such as dovetail rim slots, blade roots, and locking features are no longer required. Blisks are therefore increasingly used in modern gas turbine engines, for example as part of the compressor section (including the fan of a turbofan engine).

Typically, blisks are designed where possible to avoid vibration responses from, for example, resonance and flutter, which may be distortion driven. However, blisks lack inherent damping when compared to conventional bladed disc assemblies and resonances and flutter cannot always be avoided. Additionally, the outer surface or rim of the blisk disc portion typically forms the inner annulus for working fluid in the gas turbine engine, such as at the compressor inlet. Thus the requirement for the inner annulus position fixes the blisk outer rim radius from the engine centreline thereby determining the basic size/shape of the disc portion. Accordingly, it may not be possible to design a blisk that avoids all forced vibration responses within such constraints.

Accordingly, it is desirable to be able to provide efficient and/or effective damping to a rotor stage, for example to a bladed disc, or blisk. The present disclosure has been devised with the foregoing in mind.

GB 2255138 A describes a unitary bladed disc for a turboshaft engine provided with at least one annular damper element located in a respective circumferentially extending groove in the underside of a blade platform, the damper element having at least one scalloped portion defining a plurality of radially inwardly directed projections and recesses arranged alternately in succession around the element so that, in operation, dynamic imbalances generating frictions which have a damping effect on vibrations of the blades are created under centrifugal action. In an alternative arrangement the damper is located in a groove on the undersides of the platforms and in a groove in a radially outwardly facing surface of the disc and may be provided with axially directed projections and recesses.

JP 5030813 B2 describes a blisk used in an axial-flow type air machine, in which blades constituting a rotor and a rotor disk are integrally formed. A circumferential groove is formed so that a friction member can be inserted into the rotor disk.

U.S. Pat. No. 6,494,679 B1 describes a rotor which uses damper-ring devices for damping unwanted rotor vibrations. Such a rotor may have inner and outer damper rings with the outer damper ring providing ring-rotor frictional damping only at large vibrational amplitudes and with the inner and outer damper rings providing inter-ring frictional damping at both small and large vibrational amplitudes. Such a rotor may include a damper ring and a viscoelastic layer, a hollow damper ring containing particulate matter, and a damper ring in the form of a cable made of twisted single-wire strands.

EP 3112588 A2 describes a rotor stage of a gas turbine engine comprising a platform from which rotor blades extend. The platform is provided with a circumferentially extending damper ring, the damper ring having an engagement surface that engages with a platform engagement surface of the platform. The platform engagement surface (110) and the damper engagement surface can move relative to each other in the radial direction. In use, the damper engagement surface moves less in the radial direction than the platform engagement surface in response to diametral mode excitation. This causes friction between the two surfaces, thereby dissipating energy and damping the excitation.

### SUMMARY

According to a first aspect of the present disclosure, there is provided a rotor stage for a gas turbine engine comprising: a platform having a first material composition, a plurality of blades extending from the platform, and a damper element; wherein the platform comprises a platform engagement surface; wherein the damper element comprises a body portion and an engagement portion, the engagement portion having a second material composition comprising a composite friction material; and wherein the engagement portion comprises a damper engagement surface that engages with the platform engagement surface.

The first material composition may comprise (e.g. consist of or consist essentially of) a metal (e.g. a metal alloy). The first material composition may comprise titanium.

The composite friction material may comprise fibres or filaments which are randomly distributed and/or randomly orientated within a matrix. The composite friction material may comprise glass fibres. The composite friction material may comprise aromatic polyamide fibres. The composite friction material may comprise steel filaments.

It may be that the body portion has a third material composition which differs from the second material composition. The third material composition may be different than, or the same as, the first material composition. The third material composition may comprise (e.g. consist of, or consist essentially of) titanium or a titanium alloy.

It may be that the rotor stage comprises a load adjuster for adjusting a normal load at an interface between the damper engagement surface and the platform engagement surface, and wherein each of the composite friction material and the normal load are selected such that, in use, vibration of the platform during rotation thereof results in a stick-slip phenomenon at the interface between the damper engagement surface and the platform engagement surface.

The composite friction material (and the first material composition) may be selected such that, in use and at the interface between the platform engagement surface and the damper engagement surface, a wear rate of the composite friction material is greater than a wear rate of the first material composition.

The body portion and the engagement portion may be bonded together. The body portion and the engagement portion may be bonded together using an adhesive.

The body portion and the engagement portion may be fastened together by an interference fit.

It may be that the engagement portion is at least partially received within the body portion.

It may be that the damper element comprises a plurality of engagement portions, each engagement portion comprising a damper engagement surface that engages with the platform engagement surface.

The or each engagement portion may have the shape of a prism, such as a pin.

It may be that: the platform extends circumferentially about an axial direction; and the plurality of engagement portions are angularly distributed about the axial direction.

It may be that: the platform extends circumferentially about an axial direction; the platform engagement surface extends in a plane that is substantially perpendicular to the axial direction; and the damper engagement surface extends in a plane that is parallel to the platform engagement surface.

According to a second aspect of the present disclosure, there is provided a gas turbine engine comprising the rotor stage of any preceding claim.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION OF THE DRAWINGS

Embodiments will now be described by way of example only with reference to the accompanying drawings, which are purely schematic and not to scale, and in which:

FIG. 1 is a sectional side view of a gas turbine engine in accordance with an example of the present disclosure;

FIG. 2 is a schematic view of a part of a rotor stage of a gas turbine engine, including a damper element, in accordance with an example of the present disclosure;

FIG. 3 is a schematic view of a part of a rotor stage of a gas turbine engine, including a damper element, in accordance with an example of the present disclosure;

FIG. 4 is a schematic view of a part of a rotor stage of a gas turbine engine, including a damper element, in accordance with an example of the present disclosure;

FIG. 5 is a schematic view of a part of a rotor stage of a gas turbine engine, including a damper element, in accordance with an example of the present disclosure;

FIG. 6 is a schematic view of a part of a rotor stage of a gas turbine engine, including a damper element, in accordance with an example of the present disclosure;

FIG. 7 is a schematic view of a part of a rotor stage of a gas turbine engine, including a damper element, in accordance with an example of the present disclosure;

FIG. 8 is a schematic view of a part of a rotor stage of a gas turbine engine, including a damper element, in accordance with an example of the present disclosure;

FIG. 9 is a schematic view of a part of a rotor stage of a gas turbine engine, including a damper element, in accordance with an example of the present disclosure;

FIG. 10 is a schematic view of a part of a rotor stage of a gas turbine engine, including a damper element, in accordance with an example of the present disclosure; and

FIG. 11 is a schematic view of a damper element for a rotor stage, in accordance with an example of the present disclosure.

### DETAILED DESCRIPTION

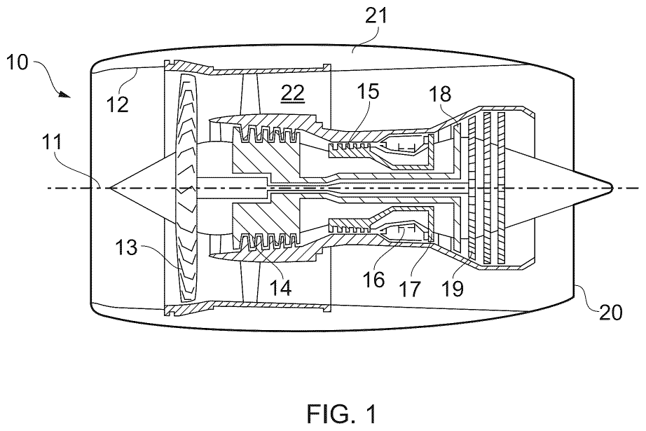

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high-pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high-pressure compressor 15, intermediate pressure compressor 14 and fan 13, each by suitable interconnecting shaft.

Each of the high 17, intermediate 18 and low 19 pressure turbines and each of the fan 13, intermediate pressure compressor 14 and high-pressure compressor 15 comprises at least one rotor stage having multiple blades (or aerofoils) that rotate in use. One or more rotor stage may be, for example, a disc with slots (which may be referred to as dovetail slots or fir-tree slots) for receiving the blade roots. One or more rotor stages may have the blades formed integrally with the supporting disc or ring structure, and may be referred to as blisks or blings. In such arrangements, the blades may be permanently attached to the supporting disc/ring, for example using friction welding, such as linear friction welding.

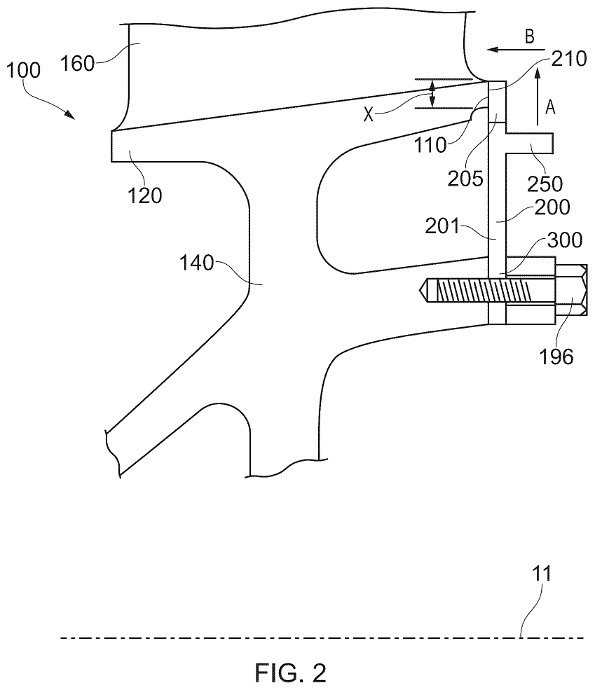

FIG. 2 shows a schematic side view of a part of a rotor stage 100, including a platform 120, a disc 140, a blade 160, and a damper element 200 (which may be a damper ring 200). The platform 120 (which may be referred to as a rim 120), disc 140 and blade 160 may all be integral, and may be referred to collectively as a blisk. The rotor stage 100 may be any one of the rotor stages of the gas turbine engine 10 shown in FIG. 1, such as (by way of non-limitative example) the fan 13 and/or any one or more stages of one or more of the high 17, intermediate 18 and low 19 pressure turbines and/or the high-pressure compressor 15 or intermediate pressure compressor 14.

In the example of FIG. 2, the damper element 200 is provided to an axial downstream surface of the platform 120. In other arrangements the damper element 200 may engage with another part of the platform 120 such as, by way of example, an axially upstream surface of the platform 120. In this regard, the downstream axial direction 11 is towards the right of the page in FIG. 2, the radially outward direction is towards the top of the page, and the circumferential direction is perpendicular to the page. Accordingly, the rotor stage 100 is shown in cross-section normal to the circumferential direction in FIGS. 2 to 10. The platform 120 extends circumferentially about the axial direction 11.

The damper element 200 may take many different forms, for example in terms of geometry and/or materials. Purely by way of example, the damper element 200 may be circumferentially continuous (for example in the form of a ring) and/or may be axisymmetric. By way of alternative example, the damper element 200 may only extend around a circumferential segment.

The damper element 200 has a damper engagement surface 210. The damper engagement surface 210 extends in the radial-circumferential direction in the example of FIG. 2.

The damper engagement surface 210 engages a corresponding platform engagement surface 110. In general terms, the platform engagement surface 110 extends in a plane that is substantially perpendicular to the axial direction 11 and the damper engagement surface 210 extends in a plane that is parallel to the platform engagement surface 110. More specifically, the platform engagement surface(s) 110 may be of the same (or overlapping) shape as the damper engagement surface(s) 210. The platform engagement surface(s) 110 and the damper engagement surface(s) 210 may be annular, as in the example of FIG. 2.

In use, excitation or vibration may cause a circumferential travelling wave to pass around the platform 120. This may be referred to as diametral mode excitation. At a given circumferential position around the circumference, such as at the cross section shown in FIG. 2, this may cause the platform to oscillate in the radial direction. As such, a given circumferential position on the platform 120 may move radially inwardly and outwardly, as illustrated by the arrow X in FIG. 2. This vibration/oscillation around the platform may, of course, occur during use of any arrangement described and/or claimed herein.

The platform engagement surface(s) 110 therefore may also experience this radial oscillation during use. However, the damper engagement surface(s) 210 do not oscillate, or at least any oscillation is of a significantly lower magnitude than that of the corresponding platform engagement surface(s) 110. This may be because the damper element 200 is not directly fixed to the platform 120. Accordingly, the vibration/excitation of the platform results in relative movement between the platform engagement surface(s) (110) and the damper engagement surface(s) 210. Accordingly, the arrow X in FIG. 2 may be taken to represent the relative movement between the platform engagement surface(s) (110) and the damper engagement surface(s) 210. This relative radial movement results in friction at an interface between the engagement surfaces 110, 210. This friction may result in energy dissipation at the interface, and may provide damping of the oscillation/vibration.

The magnitude of the damping may depend upon, amongst other factors, the engagement load between the engagement surfaces 110, 210. The engagement mode may be the normal load pushing the two engagement surfaces 110, 210 together, for example in the axial direction in FIG. 2.

The damper element 200 may comprise an axial projection 250, which may be an axially rearward (or downstream) facing projection 250 as in the example of FIG. 2. In use, as the rotor stage 100 rotates about the rotation axis 11, the various rotating parts experience forces due to centrifugal acceleration. For example, the axial projection 250 of the damper element 200 is urged radially outwardly by the rotation, in the direction indicated by arrow A in FIG. 2. This exerts a force on the rest of the damper element 200 that causes its radially outer end to be urged in an axially upstream direction, as indicated by the arrow B in FIG. 2. Thus, the damper engagement surface 210 is increasingly urged towards the platform engagement surface 110 with increasing rotational speed during use, under the action of centrifugal loading.

The rotation of the rotor stage 100 causes the damper element 100 to try to bend about a fixing position 300. The damper element 100 may be fixed to a radially static part, which may or may not be part of the rotor stage 100 itself, at the fixing position 300. In this sense, radially static may mean that it experiences substantially no radial movement during use and/or may mean that it experiences less radial movement during use than the platform 100 (and thus the platform engagement surface 110). The fixing position 300 may be static in the radial and/or axial and/or circumferential directions.

The centre of mass of the damper element 200 may be axially offset from the fixing position 300, for example axially offset in the downstream direction, as in the example of FIG. 2. Such an axially offset centre of mass may be achieved in any suitable manner, for example by using suitable geometry, such as an axial projection 250 as shown by way of example in FIG. 2.

The damper element 200 may be fixed at the fixing position 300 in any suitable manner, for example using a fastener, such as a threaded fastener 196 as shown in the example of FIG. 2. The threaded fastener 196 may itself provide an engagement load between the platform engagement surface 110 and the damper engagement surface 210, which may be referred to as an engagement pre-load. During rotation of the rotor stage 200, the total engagement load may be the sum of any engagement pre-load (for example generated by the fastener 196) and the engagement load due to the centrifugal acceleration (which may be more generally referred to as a dynamic engagement load). Of course, some arrangements in accordance with the present disclosure may not include an engagement pre-load.

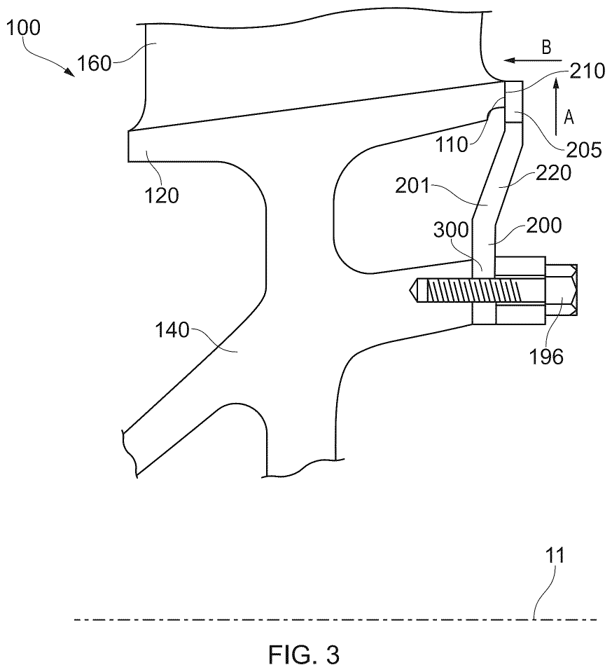

FIG. 3 shows a rotor stage 100 that is also in accordance with the present disclosure, but with a different damper element 200. In the example of FIG. 3, the damper element 200 also has a centre of mass that is axially offset from its fixing position 300, but its geometry is different to that of the damper element 200 of FIG. 2. In particular, the damper element 200 of FIG. 3 has at least a portion 220 that has a component that extends in an axial direction 11. The portion 220 may be frustoconical, as in the example of FIG. 3, for example at least a segment of a frustocone.

As with the example of FIG. 2, the damper element 200 of FIG. 3 is urged in an axially upstream direction by centrifugal loading during use, as indicated by the arrow B in FIG. 3. Thus, the damper engagement surface 210 is increasingly urged towards the platform engagement surface 110 with increasing rotational speed during use, under the action of centrifugal loading A.

The example damper arrangements 200 shown in FIGS. 2 and 3 are merely illustrative, with many other arrangements (for example different geometries) falling within the scope of the present disclosure.

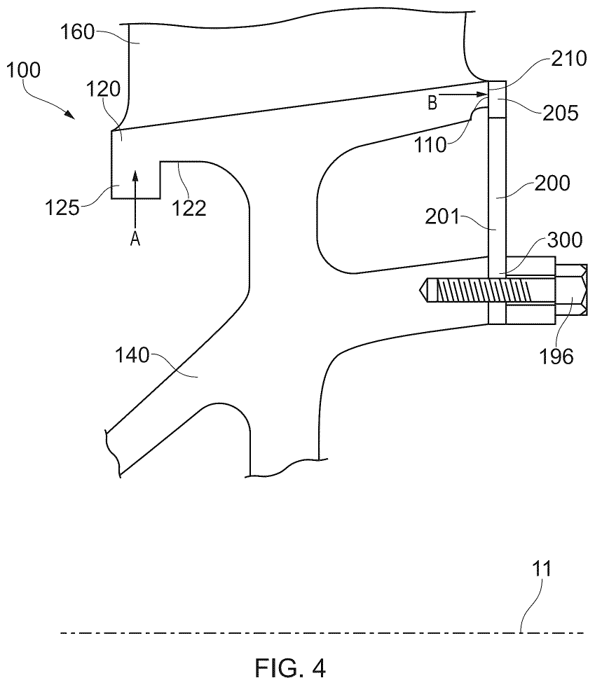

FIG. 4 shows an alternative arrangement of the rotor stage 100, wherein the rotor sage 100 comprises a platform projection 125. The platform projection 125 (which may be referred to as a platform mass 125, and may take any suitable form) extends in the radial direction. In particular, in the example of FIG. 4, the platform projection 125 extends from a lower (radially inner) surface 122 of the platform 120, in the radially inward direction.

During rotation of the rotor stage 100 in use, the stage experiences centrifugal loading. The additional mass of the platform projection 125 is centrifuged radially outwardly, as indicated by the arrow A in FIG. 4. This radially outward centrifuging causes the platform 120, and thus the platform engagement surface 110, to be urged in an axial direction, in particular an axially downstream direction B in the example of FIG. 4. In turn, this means that the engagement load between the platform engagement surface 110 and the damper engagement surface 210 increases with increasing rotational speed.

In the example of FIG. 4, the additional mass in the form of the platform projection 125 is provided axially upstream of the centre of mass of the rotor stage 100 as a whole. In alternative arrangements, additional mass, for example in the form of a platform projection 125, may be provided axially downstream of the centre of mass of the rotor stage 100 as a whole. Such an arrangement may result in the platform 120, and thus the platform engagement surface 110, to be urged in an axially upstream direction with increasing rotational speed during use.

Additional mass is provided to the platform 120 in the form of a platform projection 125 in the example of FIG. 4. However, such additional mass could be provided in any suitable form, for example through shaping of the platform 120 in a desired manner, for example relative thickening and/or thinning in desired axial positions in order to produce a desired response to rotation.

In the example of FIG. 4, the damper element 200 is in the form of an annular disc. The damper engagement surface 210 of the damper element 200 in the example of FIG. 4 is not urged either axially upstream or axially downstream by the centrifugal loading caused by rotation of the rotor stage 100. However, in other arrangements, both the damper engagement surface 210 and the platform engagement surface 110 may be axially urged by centrifugal loading, for example in opposite directions so as to be urged together. For example, the damper element 200 of FIG. 2 or FIG. 3 may be used in combination with the platform 120 of FIG. 4.

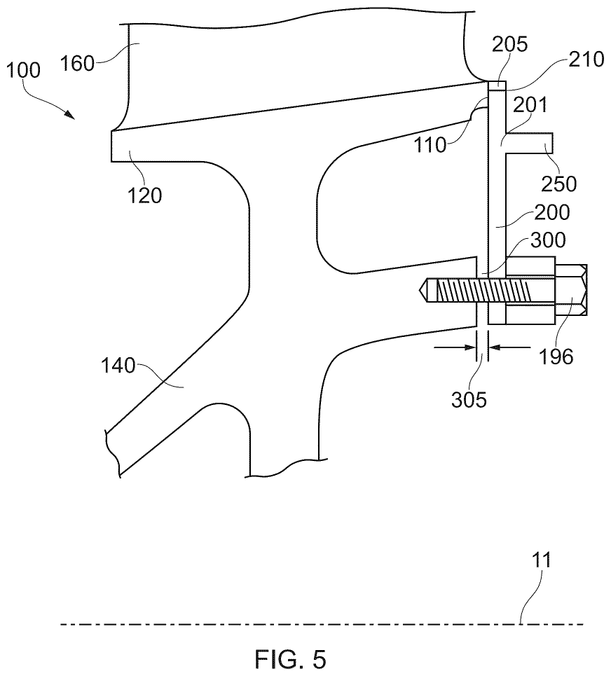

The damper arrangement 100 shown in the example of FIG. 5 is similar to that shown and described in relation to FIG. 2 above. However, in the example of FIG. 5, the fixing position 300 is provided with an adjustment portion, in the form of an adjustable axial gap 305. The gap 305 allows an axial biasing load to be applied to the damper element 200, for example by tightening the fixing element 196. For example, by tightening the fixing element 196, the damper element in the example of FIG. 5 may be urged axially upstream, generating an engagement pre-load (or static engagement load) between the damper engagement surface 210 and the platform engagement surface 110. In use, the overall engagement load may be the sum of this engagement pre-load and the engagement load generated as a result of the centrifugal loading (which may be referred to as the dynamic engagement load).

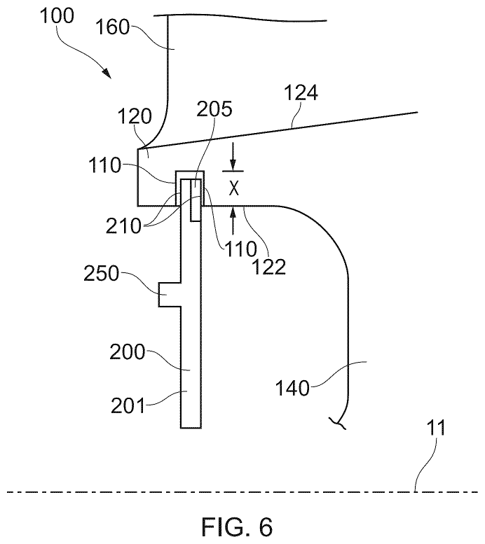

Various other features and examples are described below in relation to FIGS. 6 to 10. Each of FIGS. 6 to 10 comprises a damper element 200 having an axial protrusion 250, such as that described above in relation to FIG. 2. However, it will be appreciated that the arrangements of FIGS. 6 to 10 could additionally or alternatively be provided with any of the features described and or claimed herein that are designed to provide an engagement load between the damper engagement surface 210 and the platform engagement surface 110 that is a function of rotational speed. For example, any of the arrangements of FIGS. 6 to 10 could be provided with a platform 120 having axially offset mass, such as a platform projection 125 and/or a damper element 100 with a portion having an axially extending component, such as that shown by way of example in FIG. 3.

In the examples of FIGS. 6 to 10, the detailed attachment of the damper element 200 to the rest of the rotor stage 100 is not illustrated. However, any suitable attachment of the damper element 200 to the rest of the rotor stage 100 may be used, for example at a fixing position 300 and/or using a fixing element 196 such as that shown by way of example in FIGS. 2 to 5, for example to axially and/or radially fix a radially inner portion of the damper element 200 in position.

In the example of FIG. 6, the damper element 200 has an interference fit in a groove 180. The groove 180 is formed in the inner surface 122 of the platform 120. The groove 180 comprises first and second platform engagement surfaces 110, joined by an axially extending surface, which may be a cylindrical surface. The interference fit may provide a static engagement load (or engagement pre-load) between the platform engagement surfaces 110 and the damper engagement surface 210.

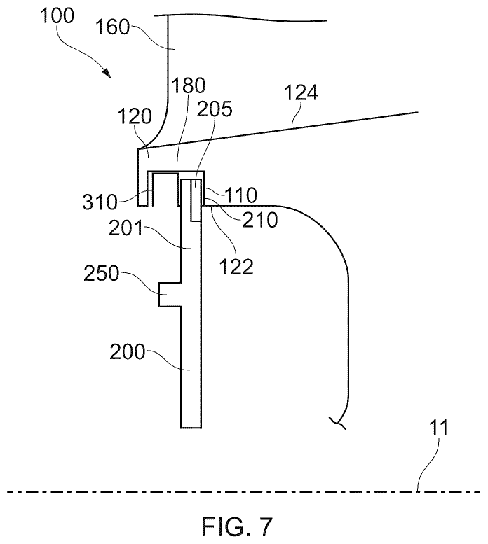

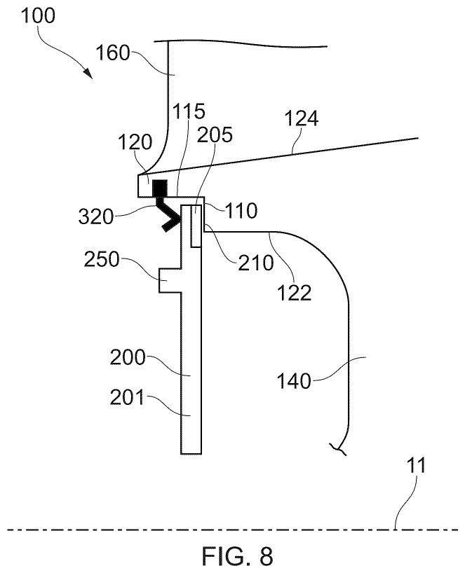

Alternatives to the interference fit of the example of FIG. 2 are shown in FIGS. 7 and 8.

The FIG. 7 arrangement also has a groove 180 formed in the platform 120. However, unlike the example of FIG. 6, in the groove 180 in the example of FIG. 7 arrangement is wider (for example extends over a greater axial distance) than the damper element 200. The FIG. 7 arrangement has just one damper engagement surface 210 that engages with just one platform engagement surface 110. The two engagement surfaces 110, 210 are pushed together by a biasing element 310. Accordingly, the biasing element 310 provides the engagement load to press the engagement surfaces 110, 210 together. The biasing element 310 may be provided in the groove 180, for example axially offset from and/or adjacent the damper element 200, as in the example of FIG. 7. The biasing element 310 may take any suitable form, such as a spring and/or a clip. In the example of FIG. 7, the biasing element 310 may be referred to as a clip 310, and may further be described as a u-shaped clip.

The FIG. 8 arrangement is similar to that of FIG. 7, other than in that it does not have a groove 180 and the biasing element 320 has a different form. Instead of being located in a groove, the damper element 200 is simply biased towards a platform engagement surface by a biasing element 320. FIG. 8 shows an example of an arrangement in which the platform engagement surface 210 is provided by way of a notch (or open notch) 115. Such a notch 115 may be formed in the radially inner surface 122 of the platform 120, as in the example of FIG. 8. Again, the biasing element 320 could take any suitable form, such as the spring 320 located and/or fixed in the platform 120 shown in the example of FIG. 8.

In general using a biasing element 310, 320 may allow an engagement pre-load (where present) to be maintained at substantially the same level throughout the service life of the damper arrangement. For example, any wear/dimensional change over time (for example due to the friction at the interface of the engagement surfaces 110, 210) may be compensated for (for example passively) by the biasing element, such that the force provided by the biasing element, and thus the engagement load, remains substantially constant over time.

As explained elsewhere herein, the relative movement of the damper engagement surface 210 and the platform engagement surface 110 may result in energy dissipation, and thus vibration damping. This relative movement may be relative radial movement (or at least predominantly radial movement with, for example, some circumferential movement) and may rely on the damper engagement surface 210 being more radially fixed in position during operation (for example during diametral mode excitation of the rotor stage 100) than the platform engagement surface 110. In some arrangements, the damper engagement element 200 may be shaped (for example in cross section perpendicular to the circumferential direction) to be particularly stiff in the radial direction.

Indeed, arrangements in which the damper elements have an axially extending projection 250 may be particularly stiff in the radial direction. Thus, such axially extending projections 250 may provide both radial stiffness and rotational-speed-dependent engagement loading.

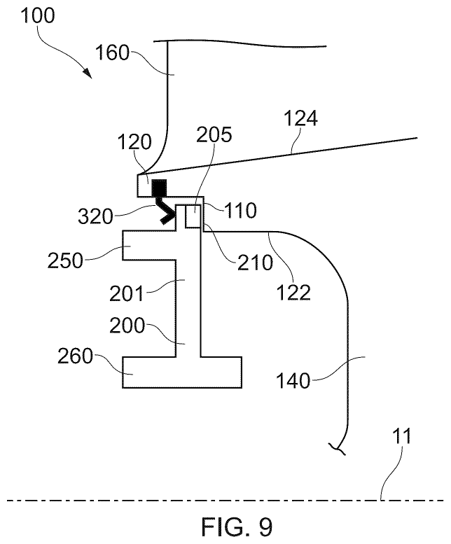

Purely by way of further example, the cross-sectional shape of the damper element 200 may comprise one or more further axial protrusions. For example, the damper element 200 shown by way of example in FIG. 9 has a cross section that comprises two additional axial protrusions 260 in cross section: one protruding axially upstream and one protruding axially downstream. A damper element 200 having such a cross section may have increased stiffness compared with one of the same mass but having a rectangular cross section.

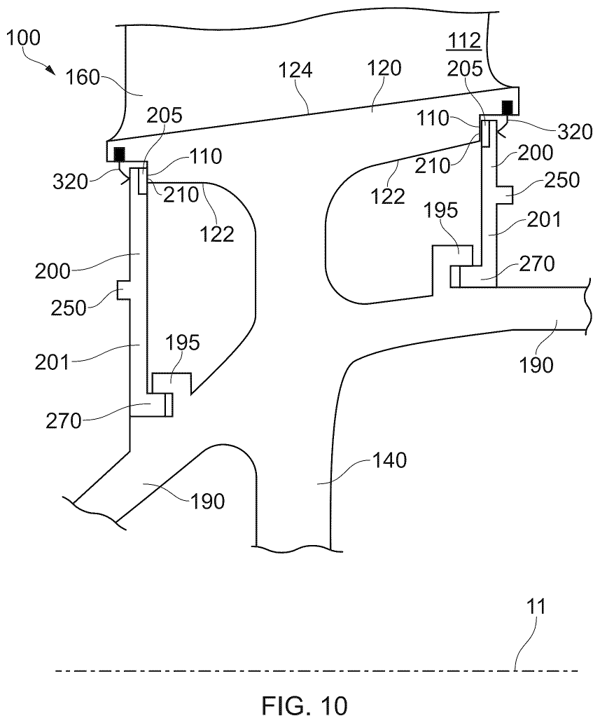

As mentioned elsewhere herein, the damper element 200 may be at least radially fixed in position at a fixing position 300, for example at a radially inner region of the damper element 200. The example shown in FIG. 10 shows an arrangement in which the damper element 200 is fixed to a drive assembly, for example including a drive arm and/or a spacer 190 and/or a disc 140. Such a drive assembly may be used as such a dimensionally stable part of the engine that rotates with the rotor stage. Such a drive assembly may be arranged to transfer torque within the engine 10.

The exemplary rotor stage shown in FIG. 10 comprises a damper element 200 with a damper fixing hook 270 that radially fixes the damper element 200 to a dimensionally stable part, in this case a drive arm 190. The damper fixing hook 270 may be described as having an axially protruding portion and/or a circumferentially extending hook locating surface. The damper fixing hook 270 is connected to a corresponding drive arm fixing hook 195. The two fixing hooks 270, 195 cooperate to radially fix the damper element 200 to the drive arm 190.

In each of the examples of FIGS. 2 to 10, the damper element 200 has a body portion 201 and an engagement portion 205. The body portion 201 is mechanically connected (e.g., affixed) to the disc 140/the drive arm 190 and extends radially upwards toward the platform 120. Accordingly, the damper element 200 may be referred to as an under-platform damper element 200. The engagement portion 205 comprises the damper engagement surface 210 that is in contact with the platform 120 (that is, the platform engagement surface 110). The platform 120 has a first material composition. For example, the first material composition may comprise a metal such as titanium. The engagement portion 205 has a different second material composition, and the body portion 201 has a different third material composition, as discussed in further detail below.

The damper engagement surface 210 is the surface that slips relative to the platform 120 during excitation (e.g., vibration) of the platform 120 as the rotor stage 100 rotates As will be appreciated by those skilled in the art, vibration of the platform 120 due to rotation thereof may generally be due to the mass distribution of the blade(s) 160 extending from the platform 120. Such vibration may be especially difficult to manage when a rotor stage incorporates a blisk. However, when slip occurs at the interface between the platform engagement surface 110 and the damper engagement surface 210, vibrational energy is removed from the platform 120 in the form of heat which is dissipated into either the adjacent metal components or the surrounding air flows (e.g., the first air flow or the second air flow described above with reference to FIG. 1).

In a previously considered arrangement of a rotor stage, the second material composition (that is, the material composition of the engagement portion) was a metal and the third material composition of the body portion was a composite such as carbon fibre. According, it was ensured that the contact between the damper engagement surface and the platform engagement surface is a metal-on-metal type of contact. However, the body portion being formed of a composite such as carbon fibre advantageously provides a damper element having a reduced mass. A similar arrangement is described by EP 3112588 A2.

Contrastingly, in arrangements of a rotor stage 100 in accordance with the present disclosure, the second material composition of the engagement portion 205 comprises a composite friction material and the third material composition of the body portion differs from the second material composition (e.g., differs from the composite friction material). In other words, the third material composition is not a composite friction material. Namely, the third material composition may comprise (e.g., consist essentially of, consist of) a metal such as titanium. The third material composition may be different than, or the same as, the first material composition of the platform 120.

Such arrangements allow the damper element 200 to be used with a greater degree of flexibility and/or effectiveness, because the frictional characteristics of the interface between the platform engagement surface 110 and the damper engagement surface 210 can be optimised according to a variety of criteria. For example, a higher level of frictional damping at the interface between the platform engagement surface 110 and the damper engagement surface 210 will reduce the vibrational amplitude of the platform 120 by removing more vibrational energy from the platform 120. A reduced vibrational amplitude of the platform 120 in turn leads to lower alternating stress in the rotor stage 100 and therefore a greater fatigue strength. For a given fatigue limit, an increased level of frictional damping at the interface between the platform engagement surface 110 and the damper engagement surface 210 means the geometry of the blade(s) 160 extending from the platform 120 does not need to be as stiff. Therefore, the blade(s) 160 may be thinned, thereby removing mass from the blade(s) 160. Any mass reduction in the blade(s) 160 will also correspond to a potential mass reduction in any containment casings and architecture of the gas turbine engine 10 in which the rotor stage 100 is incorporated.

The composite friction material may comprise aromatic polyamide fibres, which may be known as Kevlar®, Nomex®, and/or Twaron®. Preferably, the composite friction material comprises glass fibres or steel filaments in a random dispersion (e.g., filaments are randomly distributed and randomly orientated within a matrix of the composite friction material). The inventors have found that composition friction materials including such constituent parts are particularly suitable for manufacturing of the engagement portion 205 described above with reference to FIGS. 2 to 10. Namely, such materials display a relatively high coefficient of friction over a wide range of operating temperatures (i.e., have a stable coefficient of friction over a wide range of operating temperatures). This can be described as providing good temperature resistance, which is of particular importance in the context of a rotor stage 100 for a gas turbine engine 10. Further, the inventors have found that use of such materials for the engagement portion 205 enables a coefficient of dynamic friction between the platform engagement surface 110 and the damper engagement surface 210 at the interface therebetween to not be substantially less in water-contaminated or oil-contaminated conditions than in non-contaminated (e.g., dry) conditions. This may be referred to as providing good contamination resistance and/or stability. This is also of particular importance in the context of a rotor stage 100 for a gas turbine engine 10 due to the likelihood of such contamination. The composite friction material and the first material composition may preferably be selected such that a coefficient of dynamic friction between the platform engagement surface 110 and the damper engagement surface 210 at the interface therebetween in non-contaminated (e.g., dry and clean) conditions is no less than 0.15, and more preferably no less than 0.2.

In addition or instead, the composite friction material may be selected to wear in preference to the material composition of the platform engagement surface. For example, the composite friction material may be selected such that, in use and at the interface between the platform engagement surface and the damper engagement surface, a wear rate of the composite friction material is greater than a wear rate of the first material composition (that is, the material from which the platform is formed). The wear rate of each material may be defined as a volumetric loss of material per unit time, for example during actual or simulated use conditions (e.g., in a test environment using the respective parts of the rotor stage assembly). This ensures that the engagement portion 205 of the damper element 200 is worn in preference to the platform 120. The engagement portion 205 of the damper element 200 is generally more readily replaceable that the platform 120 or the platform engagement surface 100, and so this facilitates easier maintenance of the rotor stage 100.

In some examples, the body portion 201 and the engagement portion 205 are bonded together using an adhesive. In other examples, the body portion 201 and the engagement portion 205 are fastened together by means of an interference fit therebetween. If so, the engagement portion 205 of the damper element 200 may be able to safely operate at higher temperatures, for example as compared to examples in which the body portion 201 and the engagement portion 205 are bonded together using an adhesive (which may have a limit or rate temperature for operation). In various examples, the engagement portion 205 is at least partially received within (e.g., sunk into) the body portion 201. In further examples, the engagement portion 205 is in the form of a coating which is applied to the body portion 201. If so, the body portion may extend into the engagement portion 205.

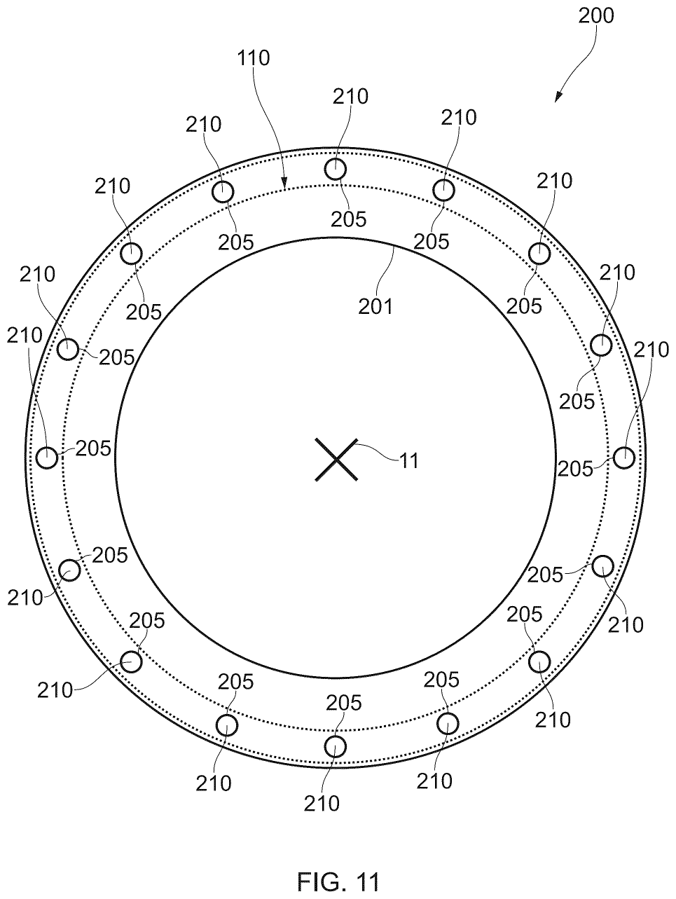

FIG. 11 shows an example damper element 200 viewed from a direction which is parallel with the axial direction 11. In the example of FIG. 11, the damper element 200 comprises a plurality of engagement portions 205 which are angularly distributed about the axial direction 11. In a similar way to the engagement portion(s) 205 described above with reference to FIGS. 2 to 10, each engagement portion 205 has a damper engagement surface 210 that engages the platform engagement surface 110 when incorporated within a rotor stage (e.g., each damper engagement surface 210 is configured to engage the platform engagement surface 110). In this example, each engagement portion 205 has the shape of a prism (e.g., a pin) that has an elongate dimension along the axial direction 11. Further, each engagement portion 205 is partially received within the body portion 201 and is fastened to the body portion 201 by means of an interference fit.

In each of the examples of FIGS. 2 to 10, the rotor stage 100 comprises a pre-load adjuster for adjusting the engagement pre-load (e.g., a normal load) between the platform engagement surface 110 and the damper engagement surface 210. Namely, the threaded fastener 196 described above with reference to FIGS. 2 to 5 may function as the pre-load adjuster, the interference fit of the damper element 200 in the groove 180 described with respect to FIG. 6 may function as the pre-load adjuster, and/or the biasing element(s) 310, 320 described with reference to FIGS. 7 to 10 may function as the pre-load adjuster.

The normal load determines a magnitude of a friction force applied at the interface between the platform engagement surface 110 and the damper engagement surface 210, which in turn controls the level of damping provided to the rotor stage 100 by the damper element 200. The normal load and the composite friction material may each be selected such that, in use, vibration of the platform 120 during rotation of the platform 120 (e.g., of the rotor stage 100) about the axial direction 11 results in a stick-slip phenomenon at the interface between the platform engagement surface 110 and the damper engagement surface 210. The frictional interaction between the platform engagement surface 110 and the damper engagement surface 210 at the interface therebetween is therefore defined by a stick-slip friction regime. This is the optimum regime for dispersing vibrational energy (e.g., kinetic energy) of the platform 120 via the damper element 200. This is because a fully slipping interface will not restrain the vibration (e.g., movement) of the platform 120, whereas a completely stuck interface will act as a fixed system and thus no vibrational energy will be removed from the platform 120 via friction at the interface.

Various examples have been described, each of which feature various combinations of features. It will be appreciated by those skilled in the art that, except where clearly mutually exclusive, any of the features may be employed separately or in combination with any other features and the present disclosure extends to and includes all combinations and sub-combinations of one or more features described herein.

It will also be appreciated that whilst the present disclosure has been described with reference to aircraft and aircraft propulsion systems, the electric machine drive techniques described herein could be used for many other applications. These include, but are not limited to, automotive, marine and land-based applications.

We claim:

1. A rotor stage (100) for a gas turbine engine (10) comprising: a platform (120) having a first material composition, a plurality of blades (160) extending from the platform, and a damper element (200);
wherein the platform comprises a platform engagement surface (110);
wherein the damper element comprises a body portion (201) and an engagement portion (205), the engagement portion having a second material composition comprising a composite friction material; and
wherein the engagement portion comprises a damper engagement surface (210) that engages with the platform engagement surface.

2. The rotor stage (100) of claim 1, wherein the composite friction material comprises fibres or filaments which are randomly distributed and/or randomly orientated within a matrix.

3. The rotor stage (100) of claim 1, wherein the composite friction material comprises glass fibres.

4. The rotor stage (100) of claim 1, wherein the composite friction material comprises steel filaments.

5. The rotor stage (100) of claim 1, wherein the body portion (201) has a third material composition which differs from the second material composition.

6. The rotor stage (100) of claim 4, comprising a load adjuster for adjusting a normal load at an interface between the damper engagement surface and the platform engagement surface, and wherein each of the composite friction material and the normal load are selected such that, in use, vibration of the platform during rotation thereof results in a stick-slip phenomenon at the interface between the damper engagement surface and the platform engagement surface.

7. The rotor stage (100) of claim 1,
wherein the composite friction material is selected such that, in use and at the interface between the platform engagement surface and the damper engagement surface, a wear rate of the composite friction material is greater than a wear rate of the first material composition.

8. The rotor stage (100) of claim 1, wherein the body portion (201) and the engagement portion (205) are bonded together.

9. The rotor stage (100) of claim 8, wherein the body portion (201) and the engagement portion (205) are bonded together using an adhesive.

10. The rotor stage (100) of claim 1, wherein the body portion (201) and the engagement portion (205) are fastened together by an interference fit.

11. The rotor stage (100) of claim 1, wherein the engagement portion (205) is at least partially received within the body portion (201).

12. The rotor stage (100) of claim 1, wherein the damper element (200) comprises a plurality of engagement portions (205), each engagement portion comprising a damper engagement surface (210) that engages with the platform engagement surface (110).

13. The rotor stage (100) of claim 12,
wherein the platform (120) extends circumferentially about an axial direction (11); and
wherein the plurality of engagement portions (205) are angularly distributed about the axial direction.

14. The rotor stage (100) of claim 1, wherein
wherein the platform (120) extends circumferentially about an axial direction (11);
wherein the platform engagement surface (110) extends in a plane that is substantially perpendicular to the axial direction; and
wherein the damper engagement surface (210) extends in a plane that is parallel to the platform engagement surface.

15. A gas turbine engine (10) comprising the rotor stage (100) of claim 1.
